(19) United States
(12) Patent Application Publication
(10) Pub. No.: US 2010/0149301 A1
(43) Pub. Date: Jun. 17, 2010

(54) Video Conferencing Subscription Using Multiple Bit Rate Streams

(75) Inventors: Ming-Chieh Lee, Bellevue, WA (US); Mu Han, Redmond, WA (US); Tim Moore, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/334,836

(22) Filed: Dec. 15, 2008

(51) Int. Cl. H04N 7/14

(52) U.S. Cl. 348/14.08; 348/E07.077

(57) ABSTRACT

Subscriptions in a video conference may be provided using multiple bit rate streams. A video conference server may receive video streams from each client in a video conference and may receive subscription requests from each client. The subscription requests may include requests to see video streams from specific other clients at a given resolution and/or frame rate. The video conference server may match up the received video streams with the subscription requests in order to send the subscribing clients their desired video streams. The server may also be able to request different versions of video streams from participants (e.g. different resolutions) and/or alter the video streams in order to better comply with the subscription request.

### RELATED APPLICATION

Related U.S. patent application Ser. No. ______, filed on even date herewith having attorney docket number 14917.1184US01/MS325426.01 and entitled “Video Conference Rate Matching,” assigned to the assignee of the present application, is hereby incorporated by reference.

### BACKGROUND

Video conference subscriptions allow clients to chose which participants they wish to see. A video conference call may use interactive telecommunication technologies that allow two and/or more locations to interact via two-way video and audio transmissions simultaneously. Video conferencing may use telecommunications of audio and video to bring people at different sites together for a meeting. This may be a conversation between two people in private offices (point-to-point) and/or may involve several sites (multi-point) with more than one person in large rooms at different sites. Besides the audio and visual transmission of meeting activities, video conferencing may be used to share documents, computer-displayed information, and whiteboards. Audio/video transmissions may be captured, recorded, and digitized using a process known as encoding, transmitted via a communications medium such as a computer network to another site, and received, decoded, and displayed to another participant in the video conference. Numerous encoding/decoding standards are compatible with this process.

A conventional strategy in video conferencing is to route a video stream from one participant to another instead of mixing the video content (decoding all incoming video streams, composing them together, and re-encoding it to a single stream and sending the re-encoded stream to every participant). Thus, some systems can only switch to and show the active speaker in a video conferencing call instead of showing videos from all participants or allowing a user to choose to see any participants they want. Furthermore, conventional systems may not allow a client to subscribe to particular streams rather than a static mixed stream nor may clients be able to receive so many streams due to bandwidth constraints.

### SUMMARY

Video conferencing subscription using multiple bit rate streams may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Video conference subscriptions may be provided. A video conference server may receive video streams in multiple, different bit rates from each client in a video conference and may receive subscription requests from each client. The subscription requests may include requests to see video streams from specific other clients at a given resolution and/or frame rate. The video conference server may match up the received video streams with the subscription requests in order to send the subscribing clients their desired video streams. The server may also be able to request different versions of video streams from participants (e.g. different resolutions) and/or alter the video streams in order to better comply with the subscription request.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of a video conference environment;

FIG. 2 is a diagram illustrating various video subscription configurations;

FIG. 3 is a diagram illustrating multiple bit rate (MBR) encoding;

FIG. 4 is a flow chart of a method for providing subscriptions in a video conference;

FIG. 5 is a flow chart of a subroutine used in the method of FIG. 4 for choosing a video stream that matches a subscription request; and

FIG. 6 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Subscriptions in a video conference may be provided. Consistent with embodiments of the present invention, a multiple bit rate (MBR) scheme may be used to stream data to clients consistent with the clients' requests to subscribe to video streams provided by other clients participating in the video conference. For example, one client may wish to see a video source stream from each of the other participating clients in a video conference simultaneously while another client only wishes to see a stream from one other client.

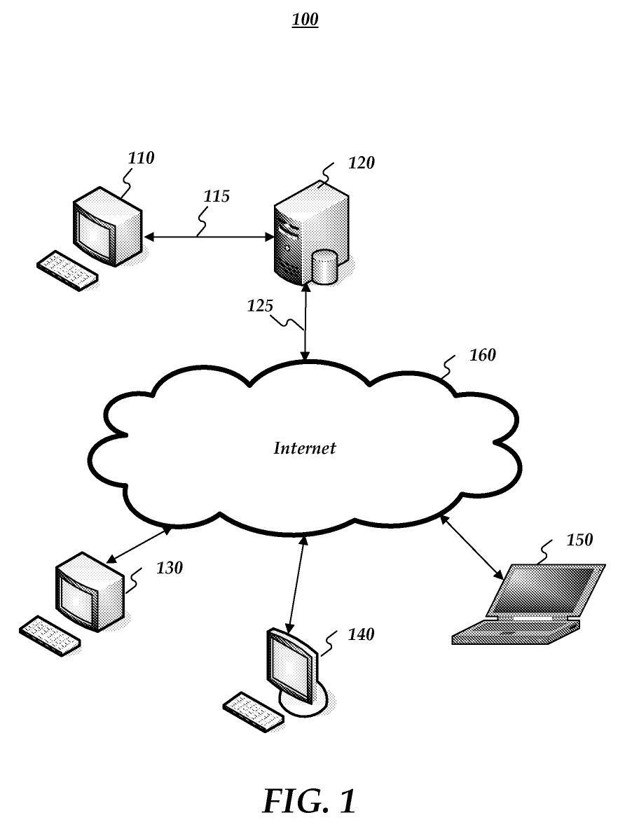

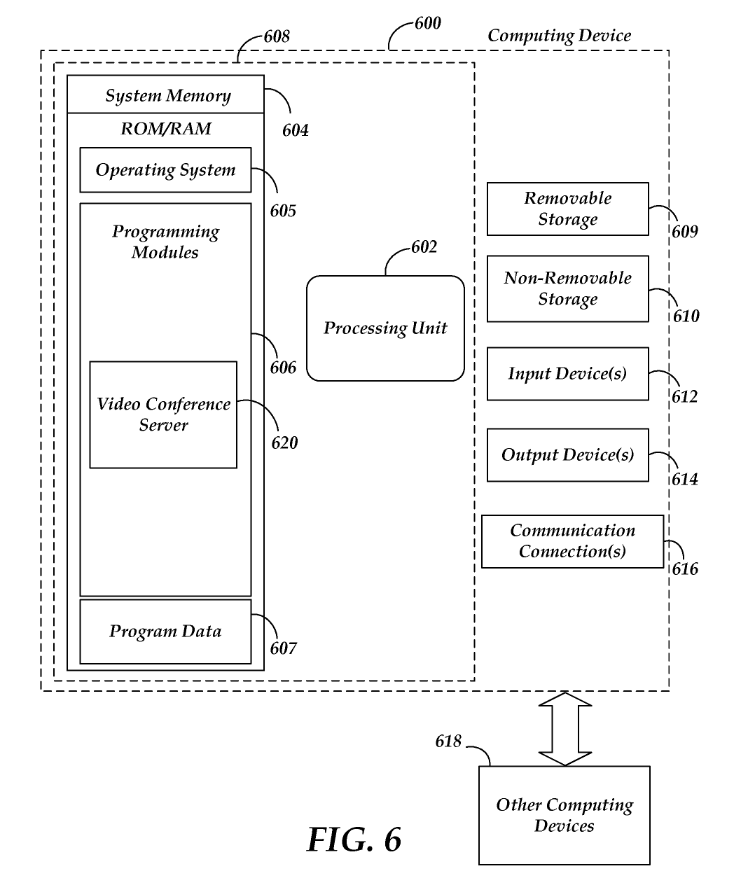

FIG. 1 is a block diagram of a video conference environment 100. Video conference environment 100 may comprise an intranet client 110 and a video conference server 120 connected via an intranet network connection 115. Video conference environment 100 may further comprise a first Internet client 130, a second Internet client 140, and a third Internet client 150. Each of the Internet clients may be connected to video conference server 120 via the Internet 160. Consistent with embodiments of the invention, video conference server 120, intranet client 110, first Internet client 130, second Internet client 140, and third Internet client 150 may each comprise a computing device 600, described below in greater detail with respect to FIG. 6.

Video conference environment 100 may be used when multiple clients want to share video streams amongst each other. Each client may connect to video conference server 120. Video conference server 120 may maintain a list of which clients are connected and what each client's capabilities are. Consistent with embodiments of the invention, video conference server 120 may be responsible for determining which clients may be responsible for sending video streams to video conference server 120. Video conference server 120 may send video streams received from clients out other connected clients. A video stream may be encoded as a series of video frames wherein each frame may comprise a single image. Each frame may be represented by bits of data. The video stream may be encoded so that not every bit of data in every frame needs to be sent in order to represent the source of the video stream. Different frame types may be used to encode and/or compress the video stream.

Each client may encode at least one video stream to send to video conference server 120. For example, each client may have an audio/video input such as a webcam and/or microphone connected to the client. The input may be used to generate a video stream (that may include audio) and the client may encode the video stream before sending it to video conference server 120. Video conference server 120 may receive encoded streams from each client and decide which streams to relay to each client. For example, intranet client 110 may encode a video stream as a series of video frames comprising a person currently talking. Video conference server 120 may send the encoded stream showing the current speaker from intranet client 110 to first Internet client 130, second Internet client 140, and third Internet client 150. Video conference server 120 may send an encoded source stream from each of first Internet client 130, second Internet client 140, and third Internet client 150 to intranet client 110 to show the audience members.

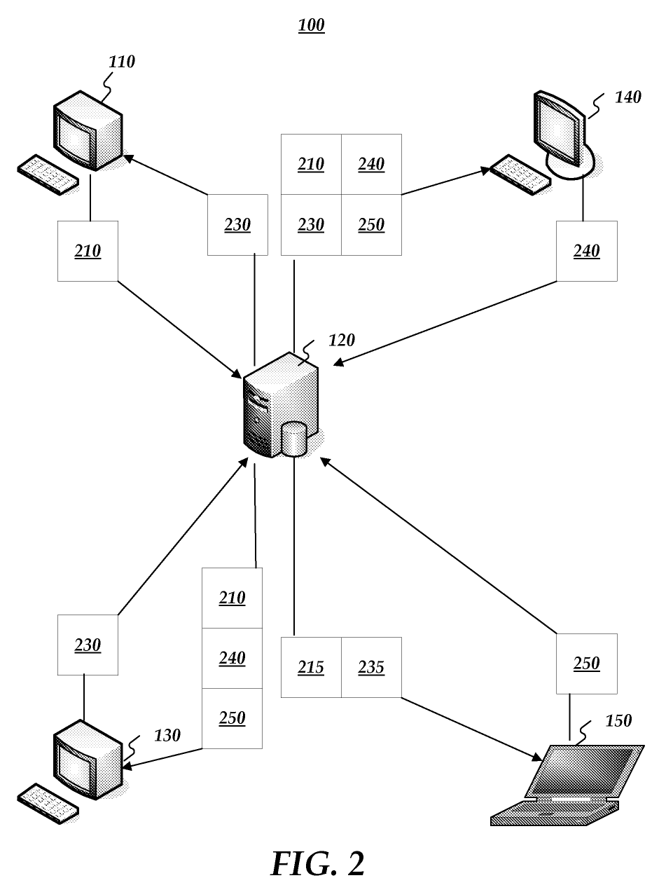

FIG. 2 is a diagram illustrating various video subscription configurations in video conference environment 100. First Internet client 130 may send a first source video stream 230 to video conference server 120. Second Internet client 140 may send a second source video stream 240 to video conference server 120. Third Internet client 150 may send a third source video stream 250 to video conference server 120. Intranet client 110 may send a fourth source video stream 210 to video conference server 120.

Each source video stream may comprise properties including a resolution and a frame rate. For example, source video streams may comprise video encoded at Hi-Definition (1280×720 pixels) resolution at 30 frames per second (fps), VGA (640×480) resolution at 30 fps, and/or CIF (320×240) resolution at 15 fps.

Each client may send a subscription request to video conference server 120. The subscription request may include requested parameters such as a source client, a resolution, and/or a frame rate. For example, intranet client 110 may request a subscription to a video stream from first Internet client 130. Video conference server 120 may determine whether a video stream matching the subscription request is available, such as first source video stream 230. Consistent with embodiments of the invention, video conference server 120 may determine whether first source video stream 230 comprises any and/or all other subscription request parameters. For example, the subscription request may include a request for a video stream from first Internet client 230 encoded with VGA resolution at 30 fps. If first source video stream 230 matches these parameters—that is, if first source video stream 230 is encoded with VGA resolution at 30 fps—video conference server 120 may relay first source video stream 230 to intranet client 110.

If first source video stream 230 does not match these parameters, video conference server may instruct first Internet client to encode an additional source video stream comprising a different version of first source video stream 230, where the different version comprises as close a match to the parameters of the subscription request as first Internet client 130 may encode. For example, first Internet client 130 may not be able to encode a source video stream with VGA resolution at 30 fps, but may be able to encode a source video stream with VGA resolution at 15 fps. First Internet client 130 may thus encode the additional source video stream with VGA resolution at 15 fps and send the additional source video stream to video conference server 120. Video conference server 120 may relay the additional source video stream to intranet client 110 in response to the subscription request from intranet client 110.

Consistent with embodiments of the invention, a video conference client may send a subscription request to video conference server 120 for more than one video stream. For example, first Internet client 130 may request a subscription to source video streams from each of the other clients participating in the video conference. Video conference server 120 may relay second source video stream 240, third source video stream 250, and fourth source video stream 210 to first Internet client 130.

Further consistent with embodiments of the invention, a client may wish to see video source streams from all participating clients in the video conference. For example, second Internet client 140 may participate in a four client video conference and request to subscribe to a 2×2 composite video stream showing all four participating clients. Video conference server may combine first source video stream 230, second source video stream 240, third source video stream 250, and fourth source video stream 210 into a single video stream using digital signal processing, arrange the four sources in a 2×2 grid, and send the single, composited video stream to second Internet client 240.

Further consistent with embodiments of the invention, a client may wish to subscribe to multiple video source streams but may not have sufficient bandwidth to receive the original versions of the requested streams. For example, third Internet client 150 may request a subscription to a video stream from intranet client 110 and first Internet client 130. The subscription may include a parameter requesting the two streams be sent in a 2×1 matrix with VGA resolution at 15 fps. If first source video stream 230 and fourth source video stream 210 are being sent to video conference server 120 with VGA resolution at 30 fps, video conference server 120 may alter each of first source video stream 230 and fourth source video stream 210, such as by removing every other frame, prior to compositing the two video streams into a new video stream for sending to third Internet client 150.

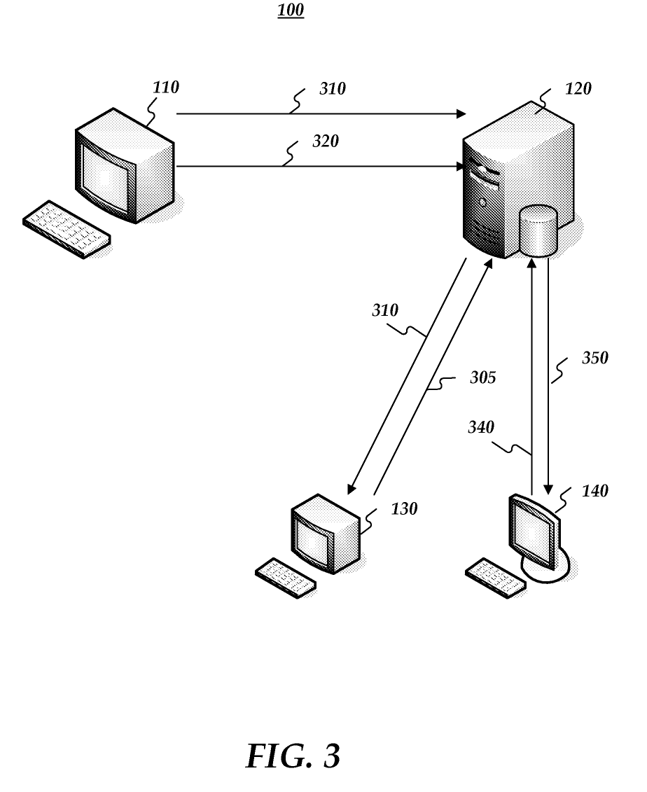

FIG. 3 is a diagram illustrating multiple bit rate (MBR) encoding. As described above with respect to FIG. 1, video conference system 100 may comprise intranet client 110, video conference server 120, first Internet client 130, and second Internet client 140. Consistent with embodiments of the invention, intranet client 110 may send a high-resolution version 310 of a source video stream and a low-resolution version 320 of a source video stream to video conference server 120 based on subscription requests from other clients. For example, first Internet client may send a subscription request 305 to video conference server 120 for a high resolution video stream from intranet client 110 and video conference server 120 may respond by relaying high-resolution version 310 of the source video stream to first Internet client 130.

Second Internet client 140 may send a subscription request 340 for a low-resolution video stream from intranet client 110 at a different frame rate than low-resolution version 320 of the video source stream being supplied by intranet client 110. Video conference server 120 may alter low-resolution version 320 to match the requested frame rate and send an altered version 350 of the video source stream to second Internet client 140.

Consistent with embodiments of the invention, a subscription request may include a mode parameter. For example, a client may wish to subscribe to video streams from all other participants but receive a current speaker's stream at a higher resolution. The client may thus send a subscription request including a speech mode parameter. Video conference server 120 may switch video streams for the client's subscription as each source video stream indicates that it is carrying the current speaker, and the currently speaking client may add an additional, higher resolution video stream while it is the current speaker. Another possible formation may have one dominant speaker client and many audience clients. The speaker may want to see many and/or all the video streams from the audience clients while the audience clients may only want to see the speaker and/or a client asking questions in a Q&A session. Video conference server 120 may allow the speaker client to subscribe all of the audience clients by requesting low-resolution streams. Video conference server 120 may alter the streams to lower frame rates if the total bandwidth for all of the lower resolution streams is still greater than what the speaker client can handle. Consistent with embodiments of the invention, the speaker client can switch to view one audience client or a multiple audience clients. The audience clients may send higher-resolution video streams to video conference server 120 if, for example, the number of audience clients is less than a configurable threshold.

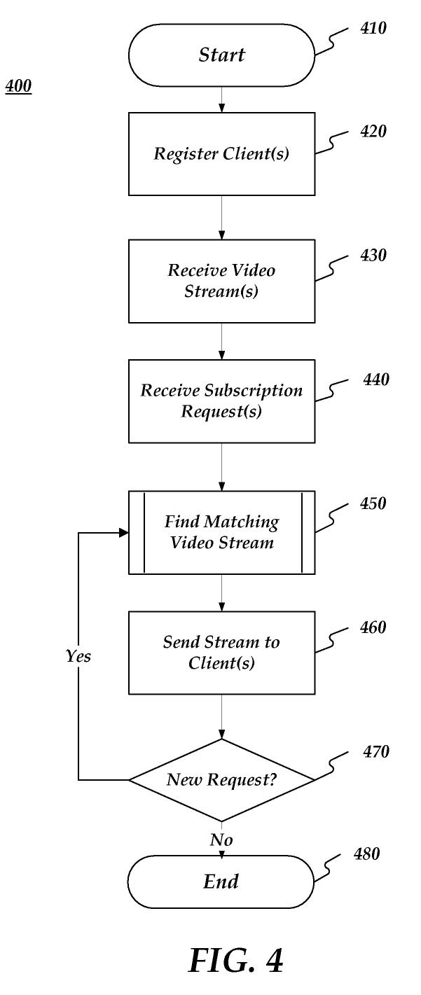

FIG. 4 is a flow chart setting forth the general stages involved in a method 400 consistent with an embodiment of the invention for providing subscriptions in a video conference. Method 400 may be implemented using a computing device 600 as described in more detail below with respect to FIG. 6. Ways to implement the stages of method 400 will be described in greater detail below. Consistent with embodiments of the invention, any and/or all of the stages of method 400 may be performed on video conference server 120 and/or any of the plurality of video conference clients.

Method 400 may begin at starting block 410 and proceed to stage 420 where computing device 600 may register at least one client. For example, the at least one client may be operatively connected to computing device 600 via a network connection and may request participation in a video conference call hosted by computing device 600.

As part of the registration, computing device 600 may determine the capabilities of the at least one client, including the computing power and encoding/decoding schemes available, and may ask the at least one client to provide a plurality of video streams in multiple, different bit rates. Consistent with embodiments of the invention, computing device 600 may request the at least one client to provide several streams if the client has the capability, but may ask the client to provide only one stream if the client has a low amount of computing power, processor cycles, memory, and/or bandwidth available.

From stage 420, method 400 may advance to stage 430 where computing device 600 may receive at least one encoded video stream from the at least one client. Multiple clients may participate in the video conference, and each client may send at least one video stream. For example, computing device 600 may receive an audio/video stream encoded with VGA resolution at 30 fps from at least one client. Consistent with embodiments of the invention, computing device 600 may receive multiple streams from at least one client. For example, a client may send three versions of the video stream: one encoded with high-definition resolution at 30 fps, one encoded with VGA resolution at 30 fps, and one encoded with CIF resolution at 15 fps.

From stage 430, method 400 may advance to stage 440 where computing device 600 may receive a subscription request from at least one client in the video conference. For example, computing device 600 may receive a subscription request from one client for a VGA encoded, 30 fps stream from a second client. Consistent with embodiments of the invention, computing device 600 may receive multiple subscription requests from any and/or all of the clients participating in the video conference. For example, one client may request lower resolution versions of all the other participating clients; another client may request a high resolution version from whichever client may be designated an active speaker in the video conference and low resolution versions from some or all of the other clients.

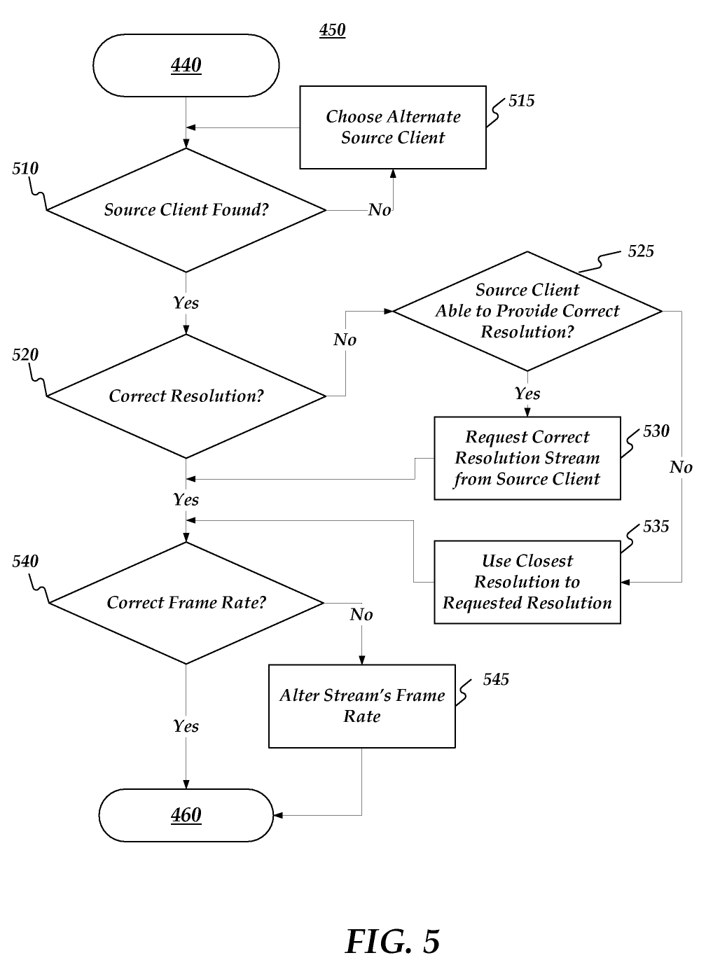

From stage 440, method 400 may advance to subroutine 450 where computing device 600 may find a video stream matching the subscription request to send to at least one client. For example, computing device 600 may determine that the second client is already sending a VGA encoded, 30 fps video stream to computing device 600 and so computing device 600 may determine that this video stream matches the subscription request. Further details regarding subroutine 450 will be described below with respect to FIG. 5.

From subroutine 450, method 400 may advance to stage 460 where computing device 600 may send the matching stream to the client. For example, computing device 600 may relay the matching video stream received from the second client over a network connection to the client that sent the subscription request.

From stage 460, method 400 may advance to stage 470 where computing device 600 may determine whether any more subscription requests have been received. Subscription requests may comprise requests to change an existing subscription, such as where one client requests a low resolution version of a stream the client is already receiving. Such a request may be made, for example, in response to a drop in available bandwidth. Subscription requests may also comprise a request, by a client already receiving at least one video stream, for video streams from an additional client(s) or requests from other clients in the video conference.

If computing device 600 determines that the another subscription request has been received, method 400 may return to subroutine 450 and attempt to find a matching video stream. If no additional subscription requests are received, computing device 600 may continue to wait for additional requests until the end of the video conference, when method 400 may end at stage 480.

FIG. 5 is a flow chart of a subroutine used in the method of FIG. 4 for choosing a video stream that matches a subscription request. In subroutine 450, computing device 600 may analyze properties associated with the subscription request, such as a source client for the requested video stream. Subroutine 450 may begin at stage 510, where computing device 600 may determine whether a video stream associated with the requested source client is available. This determination may comprise determining whether the source client is connected to the video conference, whether the source client is currently sending a video stream to computing device 600, and/or whether the source client may be capable of sending a video stream if requested by computing device 600 and/or another client in the video conference. If, at stage 510, computing device 600 determines that the requested source client may not be able to provide the requested video stream, subroutine 450 may advance to stage 515, where computing device 600 may choose an alternate source client according to predefined logic. For example, computing device 600 may pick a client designated as an active speaker. Consistent with embodiments of the invention, computing device 600 may return an error to the requesting client informing the client that the requested subscription is not available. Computing device 600 may continue to make periodic determinations as to whether the requested source client becomes available throughout the video conference. If an alternate source client is chosen at stage 515, subroutine 450 may return to stage 510 to determine whether the newly chosen source client is available.

If, at stage 510, computing device 600 determines that the requested source client is available and/or may be capable of providing a video stream, subroutine 450 may advance to stage 520, where computing device 600 may determine whether the source client associated with the subscription request is currently sending a video stream at a resolution associated with the subscription request. For example, a client may request a subscription to a source client's video stream at a VGA (640×480) resolution. Computing device 600 may determine whether the source client is providing a VGA resolution version of its video stream. If not, subroutine 450 may advance to stage 525 where computing device 600 may determine whether the source client is able to provide a video stream at the correct resolution.

If, at stage 525, computing device 600 determines that the source client is able to provide a video stream at the requested resolution, subroutine 450 may advance to stage 530, where computing device 600 may request the source client to begin sending a video stream at the requested resolution. If the source client is determined not to be able to provide a video stream at the requested resolution, subroutine 450 may advance to stage 535, where computing device 600 may choose to use another version of the source client's video stream at the closest possible resolution. For example, the source client may be able to provide a CIF resolution video stream instead of a VGA resolution video stream.

Once a video stream resolution has been chosen by computing device 600, subroutine 450 may advance to stage 540, where computing device 600 may determine whether the video stream is available at a frame rate associated with the subscription request. If the stream chosen at stage 520 does not match the requested frame rate, subroutine 450 may advance to stage 545, where computing device 600 may alter the video stream, such as by removing alternate frames to reduce frame rate. For example, computing device 600 may receive a subscription request for a VGA resolution video stream at 15 fps, but the video stream provided by the source client may be encoded at 30 fps. Computing device 600 may, for example, drop frames from the video stream to reduce the frame rate. Consistent with embodiments of the invention, computing device 600 may determine whether the source client is able to encode and send a video stream at the requested frame rate, similar to the process of stage 525 regarding resolution, and may request that the source client send a matching stream to computing device 600. From stage 540 and/or stage 545, subroutine 450 may return to method 400 at stage 460.

Consistent with embodiments of the invention, a subscription request may provide alternate acceptable values for properties such as source client, resolution, and frame rate. For example, a subscription request may comprise a request for a video stream from a first client and may indicate that a video stream from a second client is also acceptable. Similarly, a subscription request may prioritize requested resolution, such as preferring a high-definition video stream if available, indicating that a VGA resolution stream is also acceptable, but requesting that computing device 600 not send the video stream in response to the subscription request if only a CIF resolution stream is available.

An embodiment consistent with the invention may comprise a system for providing data to a plurality of clients. The system may comprise a memory storage and a processing unit coupled to the memory storage. The processing unit may be operative to receive at least one video stream from at least one first client, receive a video subscription request from at least one second client, determine whether the at least one video stream received from the at least one first client matches the video subscription request from the at least one second client, and in response to determining that the at least one video stream received from the at least one first client matches the video subscription request from the at least one second client, send the at least one video stream received from the at least one first client to the at least one second client. The video subscription request may comprise a requested resolution and/or a requested frame rate. If the at least one video stream received from the at least one first client does not match the video subscription request from the at least one second client, the processing unit may be operative to send an instruction to the at least one first client to stop encoding and sending the at least one video stream.

Consistent with embodiments of the invention, the processing unit may be operative to register a plurality of clients participating in a video conference, receive at least one video stream from each of the plurality of clients, receive at least one video subscription request from each of the registered clients, determine whether the at least one video subscription request from each of the registered clients matches at least one of the video streams received from the plurality of clients, and send the matching at least one of the received video streams to each of the plurality of clients. Determining a match between a subscription request and a received video stream may comprise determining whether the video stream matches a requested source client, a requested resolution, and/or a requested frame rate of the subscription request.

If a received video stream does not match at least one of the subscription requests, the processor may be operative to determine whether at least one received video stream can be altered to match the at least one video subscription request, alter the video stream, and send the altered video stream to the requesting client. Altering the video stream may comprise re-encoding the video stream at a different resolution, dropping at least one frame from the video stream, and/or combining at least two of the received video streams into a single video stream. Consistent with further embodiments of the invention, the processing unit may be operative to determine whether a video stream source client associated with the subscription request is capable of encoding a video stream that would satisfy the subscription request. If the source client is able to do so, the processing unit may send an instruction to the video stream source client to encode a matching video stream and send the resulting, matching video stream to the requesting at least one of the registered clients. Being operative to determine whether a source client is capable of sending a matching video stream may comprise being operative to determine whether the video stream source client is capable of encoding two different versions of a video stream, where the two versions differ in resolution and/or frame rate.

If the processing unit determines that at least one subscription request cannot be satisfied by a received video stream and/or none of the clients may be able to provide the requested video stream, the processing unit may be operative to calculate which of the received video streams most closely matches the at least one video subscription request and send the video stream most closely matching the at least one video subscription request to the requesting at least one of the registered clients. For example, the processing unit may determine whether at least one of the video streams matches a video stream source client associated with the subscription request, whether the at least one of the video streams matching the video stream source client associated with the subscription request matches a resolution associated with the subscription request, and/or whether the at least one of the video streams matching the video stream source client and the resolution associated with the subscription request matches a frame rate associated with the subscription request. The processing unit may send the at least one of the video streams to the requesting client.

If the processing unit determines that at least one of the video streams does not match a video stream source client associated with the subscription request, the processing unit may be operative to choose a second video stream source client from among the plurality of clients other than the video stream source client associated with the subscription request and send at least one video stream received from the chosen second video stream source client to the requesting client. Choosing a second video stream source client from among the plurality of clients other than the video stream source client associated with the subscription request may comprise choosing the second video stream source client that is sending a video stream comprising a current speaker.

Another embodiment consistent with the invention may comprise a system for providing video streams to a plurality of clients. The system may comprise a memory storage and a processing unit coupled to the memory storage. The processing unit may be operative to register a plurality of video conference clients, receive, from each of the plurality of video conference clients, at least one source video stream, receive, from at least one of the plurality of video conference clients, at least one video stream subscription request, determine whether at least one first stream of the source video streams received from each of the plurality of video conference clients matches the at least one video stream subscription request, and in response to determining that at least one first stream of the source video streams received from each of the plurality of video conference clients matches the at least one video stream subscription request, send the matching at least one first stream of the source video streams to the requesting at least one of the plurality of video conference clients. The processing unit may be further operative to receive, from the at least one of the plurality of video conference clients, at least one second video stream subscription request, determine whether at least one second stream of the source video streams received from each of the plurality of video conference clients matches the at least one second video stream subscription request, and in response to determining that at least one second stream of the source video streams received from each of the plurality of video conference clients matches the at least one second video stream subscription request, send the matching at least one second stream of the source video streams to the requesting at least one of the plurality of video conference clients.

Consistent with embodiments of the invention, being operative to send the matching at least one second stream of the source video streams to the requesting at least one of the plurality of video conference clients may comprise the processing unit being operative to create a composite video stream of the matching at least one first stream of the source video streams and the matching at least one second stream of the source video stream and send the composite video stream to the requesting at least one of the plurality of video conference clients.

The processing unit may be further operative to receive at least one second source video stream from at least one of the plurality of video conference clients, wherein the at least one second source video stream comprises a different version of the at least one source video stream. The different version may comprise a lower resolution version of the at least one first video source stream.

The processing unit may be operative to receive at least one first video source stream from at least one first video conference client, receive at least one second video source stream from at least one second video conference client, receive, from at least one third video conference client, a subscription request for a source video stream from the at least one first video conference client and the at least one second video conference client, and create a composite video stream of the at least one first video source stream and the at least one second video source stream. Being operative to create the composite video stream may comprise being operative to alter the frame rate of at least one of the video source streams and combine the altered stream(s) into a single video stream.

Yet another embodiment consistent with the invention may comprise a system for providing rate matching in a video conference. The system may comprise a memory storage and a processing unit coupled to the memory storage. The processing unit may be operative to receive a plurality of video streams from a plurality of video conference clients, receive at least one subscription request from at least one of the plurality of video conference clients, and determine whether the requested at least one of the plurality of video streams is being received from a source client for the requested at least one of the plurality of video streams in the requested resolution and the requested frame rate. If none of the plurality of video streams matches the requested resolution and/or frame rate, the processing unit may be operative to determine whether the source client is capable of sending a matching video stream, request that the source client do so, and send the matching video stream to the requesting client. The subscription request may comprises a request for at least one of the plurality of video streams, a requested resolution, and/or a requested frame rate. Each client may send at least one of the plurality of video streams.

FIG. 6 is a block diagram of a system including computing device 600. Consistent with an embodiment of the invention, the aforementioned memory storage and processing unit may be implemented in a computing device, such as computing device 600 of FIG. 6. Any suitable combination of hardware, software, or firmware may be used to implement the memory storage and processing unit. For example, the memory storage and processing unit may be implemented with computing device 600 or any of other computing devices 618, in combination with computing device 600. The aforementioned system, device, and processors are examples and other systems, devices, and processors may comprise the aforementioned memory storage and processing unit, consistent with embodiments of the invention. Furthermore, computing device 600 may comprise an operating environment for system 100 as described above. System 100 may operate in other environments and is not limited to computing device 600.

With reference to FIG. 6, a system consistent with an embodiment of the invention may include a computing device, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination. System memory 604 may include operating system 605, one or more programming modules 606, and may include a program data 607. Operating system 605, for example, may be suitable for controlling computing device 600's operation. In one embodiment, programming modules 606 may include, for example, a data analysis module and/or a video conference server 620. Furthermore, embodiments of the invention may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 (e.g. video conference server 620) may perform processes including, for example, one or more of method 400's stages as described above. The aforementioned process is an example, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing video stream subscription, the method comprising:
receiving at least one video stream from at least one first client;
receiving a video subscription request from at least one second client;
determining whether the at least one video stream received from the at least one first client matches the video subscription request from the at least one second client; and
in response to determining that the at least one video stream received from the at least one first client matches the video subscription request from the at least one second client, sending the at least one video stream received from the at least one first client to the at least one second client.

2. The method of claim 1, wherein the video subscription request comprises at least one of: a requested resolution and a requested frame rate.

3. The method of claim 1, further comprising:
in response to determining that the at least one video stream received from the at least one first client does not match the video subscription request from the at least one second client, sending an instruction to the at least one first client to stop encoding and sending the at least one video stream.

4. The method of claim 1, further comprising:
registering a plurality of clients;
receiving at least one video stream from each of the plurality of clients;
receiving at least one video subscription request from each of the registered clients;
determining whether the at least one video subscription request from each of the registered clients matches at least one of the video streams received from the plurality of clients; and
in response to determining that the at least one video subscription request from each of the registered clients matches at least one of the video streams received from the plurality of clients, sending the matching at least one of the received video streams to each of the plurality of clients.

5. The method of claim 4, wherein determining whether the at least one video subscription request from each of the registered clients matches at least one of the video streams received from the plurality of clients comprises determining whether at least one of the received video streams comprises at least one of: a requested source client, a requested resolution, and a requested frame rate of the subscription request from each of the registered clients.

6. The method of claim 4, further comprising:
in response to determining that at least one video subscription request from at least one of the registered clients cannot be satisfied by at least one of the video streams received from the plurality of clients, determining whether at least one received video stream can be altered to match the at least one video subscription request;
in response to determining that at least one received video stream can be altered to match the at least one video subscription request; altering the received video stream; and
sending the altered video stream to the requesting at least one of the registered clients.

7. The method of claim 6, wherein altering the video stream comprises at least one of: re-encoding the video stream at a different resolution, dropping at least one frame from the video stream, and combining at least two of the received video streams into a single video stream.

8. The method of claim 4, further comprising:
in response to determining that at least one video subscription request from at least one of the registered clients cannot be satisfied by at least one of the video streams received from the plurality of clients, determining whether a video stream source client associated with the subscription request is capable of encoding a matching video stream;
in response to determining that a video stream source client associated with the subscription request is capable of encoding a matching video stream, sending an instruction to the video stream source client to encode a matching video stream; and
sending the matching video stream to the requesting at least one of the registered clients.

9. The method of claim 8, wherein determining whether a video stream source client associated with the subscription request is capable of sending a matching video stream comprises determining whether the video stream source client is capable of encoding at least two video streams comprising at least one of: a different resolution and a different frame rate.

10. The method of claim 4, further comprising:
in response to determining that at least one video subscription request from at least one of the registered clients cannot be satisfied by at least one of the video streams received from the plurality of clients, calculating which of the video streams most closely matches the at least one video subscription request; and
sending the video stream most closely matching the at least one video subscription request to the requesting at least one of the registered clients.

11. The method of claim 10, wherein calculating which of the video streams most closely matches the at least one video subscription request comprises:
determining whether at least one of the video streams matches a video stream source client associated with the subscription request;
in response to determining that at least one of the video streams matches a video stream source client associated with the subscription request, determining whether the at least one of the video streams matching the video stream source client associated with the subscription request matches a resolution associated with the subscription request,
in response to determining that the at least one of the video streams matches the video stream source client and the resolution associated with the subscription request, determine whether the at least one of the video streams matching the video stream source client and the resolution associated with the subscription request matches a frame rate associated with the subscription request, and
in response to determining that the at least one of the video streams matches the video stream source client and the resolution associated with the subscription request but not the frame rate associated with the subscription request, send the at least one of the video streams to the requesting client.

12. The method of claim 11, further comprising:
in response to determining that at least one of the video streams does not match a video stream source client associated with the subscription request:
choosing a second video stream source client from among the plurality of clients other than the video stream source client associated with the subscription request, and
sending at least one video stream received from the chosen second video stream source client to the requesting client.

13. The method of claim 12, wherein choosing a second video stream source client from among the plurality of clients other than the video stream source client associated with the subscription request comprises choosing the second video stream source client that is sending a video stream comprising a current speaker.

14. A computer-readable medium which stores a set of instructions which when executed performs a method for providing video streams subscription, the method executed by the set of instructions comprising:
registering a plurality of video conference clients;
receiving, from each of the plurality of video conference clients, at least one source video stream;
receiving, from at least one of the plurality of video conference clients, at least one video stream subscription request;
determining whether at least one first stream of the source video streams received from each of the plurality of video conference clients matches the at least one video stream subscription request; and
in response to determining that at least one first stream of the source video streams received from each of the plurality of video conference clients matches the at least one video stream subscription request, sending the matching at least one first stream of the source video streams to the requesting at least one of the plurality of video conference clients.

15. The computer-readable medium of claim 14, further comprising:
receiving, from the at least one of the plurality of video conference clients, at least one second video stream subscription request;
determining whether at least one second stream of the source video streams received from each of the plurality of video conference clients matches the at least one second video stream subscription request; and
in response to determining that at least one second stream of the source video streams received from each of the plurality of video conference clients matches the at least one second video stream subscription request, sending the matching at least one second stream of the source video streams to the requesting at least one of the plurality of video conference clients.

16. The computer-readable medium of claim 15, wherein sending the matching at least one second stream of the source video streams to the requesting at least one of the plurality of video conference clients comprises:
creating a composite video stream of the matching at least one first stream of the source video streams and the matching at least one second stream of the source video streams; and
sending the composite video stream to the requesting at least one of the plurality of video conference clients.

17. The computer-readable medium of claim 14, further comprising receiving at least one second source video stream from at least one of the plurality of video conference clients, wherein the at least one second source video stream comprises a different version of the at least one source video stream.

18. The computer-readable medium of claim 14, further comprising:
receiving, from at least one first video conference client, at least one first video source stream and at least one second video source stream, wherein the at least one second video source stream comprises a lower resolution version of the at least one first video source stream;
receiving, from at least one second video conference client, at least one first video source stream and at least one second video source stream, wherein the at least one second video source stream comprises a lower resolution version of the at least one first video source stream;
receiving, from at least one third video conference client, a subscription request for a source video stream from the at least one first video conference client and the at least one second video conference client;
creating a composite video stream of the at least one second video source stream from the at least one first video conference client and the at least one second video source stream from the at least one second video conference client; and
sending the composite video stream to the at least one third video conference client.

19. The computer-readable medium of claim 14, further comprising:
receiving at least one first video source stream from at least one first video conference client;
receiving at least one second video source stream from at least one second video conference client;
receiving, from at least one third video conference client, a subscription request for a source video stream from the at least one first video conference client and the at least one second video conference client;
creating a composite video stream of the at least one first video source stream and the at least one second video source stream, wherein creating the composite video stream comprises:
altering the frame rate of the at least one first video source stream,
altering the frame rate of the at least one second video source stream, and
combining the altered first video source stream and the altered second video source stream into a single video stream; and
sending the composite video stream to the at least one third video conference client.

20. A system for providing subscriptions in a video conference, the system comprising:
a memory storage; and
a processing unit coupled to the memory storage, wherein the processing unit is operative to:
receive a plurality of video streams from a plurality of video conference clients, wherein each client sends at least one of the plurality of video streams;
receive at least one subscription request from at least one of the plurality of video conference clients, wherein the subscription request comprises a request for at least one of the plurality of video streams, a requested resolution, and a requested frame rate;
determine whether the requested at least one of the plurality of video streams is being received from a source client for the requested at least one of the plurality of video streams in the requested resolution and the requested frame rate;
in response to determining that the requested at least one of the plurality of video streams is not being received from a source client for the requested at least one of the plurality of video streams in the requested resolution and the requested frame rate, determine whether the source client for the requested at least one of the plurality of video streams is capable of sending the requested at least one of the plurality of video streams in the requested resolution at the requested frame rate;
in response to determining that the source client for the requested at least one of the plurality of video streams is capable of sending the requested at least one of the plurality of video streams in the requested resolution at the requested frame rate, send an instruction to the source client for the requested at least one of the plurality of video streams to encode and send the requested at least one of the plurality of video streams in the requested resolution at the requested frame rate to the system; and
send the requested at least one of the plurality of video streams in the requested resolution at the requested frame rate to the at least one of the plurality of video conference clients sending the subscription request.
